(19) United States
(12) Patent Application Publication
(10) Pub. No.: US 2014/0346248 A1
(43) Pub. Date: Nov. 27, 2014

(54) REMOVAL DEVICE FOR A CROP PROTECTION AGENT

(71) Applicants: Robert Huber, Limburgerhof (DE); Karl-Heinz Koch, Kapellen-Drusweiler (DE); Harald Kröger, Bohl-Iggelheim (DE); Heinz-Gerd Wegkamp, Lampertheim (DE); Christian-Andreas Winkler, Mannheim (DE)

(72) Inventors: Robert Huber, Limburgerhof (DE); Karl-Heinz Koch, Kapellen-Drusweiler (DE); Harald Kröger, Bohl-Iggelheim (DE); Heinz-Gerd Wegkamp, Lampertheim (DE); Christian-Andreas Winkler, Mannheim (DE)

(73) Assignee: BASF SE, Ludwigshafen (DE)

(21) Appl. No.: 14/362,507

(22) PCT Filed: Dec. 5, 2012
(86) PCT No.: PCT/EP2012/074452

§ 371 Date: Jun. 3, 2014

(30) Foreign Application Priority Data
Dec. 9, 2011 (EP) 11192862.8

(51) Int. Cl. B05B 9/04; A01G 13/00; B05B 12/08

(52) U.S. Cl. CPC B05B 9/0416; B05B 12/08; A01G 13/00
USPC 239/71; 239/302

(57) ABSTRACT

The present invention relates to a discharge apparatus for a plant protection product with a container (1), which has a container wall (8, 18, 19) and a discharge orifice (9), the container wall (8, 18, 19) enclosing an interior (7) for accommodating the plant protection product, and a pump (2, 6), which comprises a delivery unit (2) and a drive unit (6). The discharge apparatus according to the invention is characterized in that the delivery unit (2) is arranged in the interior (7) of the container (1) in such a way that plant protection product located in the container (1) can be delivered out of the container (1) through the discharge orifice (9) of the container (1) by means of the delivery unit (2), and the drive unit (6) is arranged outside the interior (7) of the container (1) and drives the delivery unit (2).

The present invention relates to a discharge apparatus for a plant protection product. The discharge apparatus comprises a container which has a container wall and a discharge orifice. In this case, the container wall encloses an interior for accommodating the plant protection product. Furthermore, the discharge apparatus comprises a pump, which comprises a delivery unit and a drive unit.

Plant protection product containers are known in which the plant protection product is discharged through the discharge orifice by rotating the container manually such that the discharge orifice is arranged at the bottom. A line may then be connected to the discharge orifice and the plant protection product escapes through the discharge orifice under the effect of gravity.

Such plant protection product containers have the disadvantage that such turning of the container requires a large amount of force and can no longer be carried out in the case of relatively large and relatively heavy containers. If a plant protection product container contains more than 15 I of plant protection product, manual turning of the container is at best possible only with severe difficulty.

It is furthermore known to discharge the plant protection product from relatively large containers by means of a pump. To this end, the discharge orifice is connected via a hose to the pump which, from the outside, aspirates the plant protection product located in the interior of the container.

Such discharge apparatuses have the disadvantage that those parts of the delivery unit of the pump which come into contact with the plant protection product have possibly already been used in connection with containers which contained another plant protection product. In this case, there is the risk that, upon discharge of the plant protection product through the delivery unit of the pump, the plant protection product will become contaminated with another plant protection product or other residues in the delivery unit of the pump. Such instances of contamination should be unconditionally avoided, however.

The object of the present invention is accordingly to specify a discharge apparatus for a plant protection product of the type mentioned in the introduction in which the plant protection product is protected against contamination.

Said object is achieved according to the invention by a discharge apparatus having the features of claim 1. Advantageous embodiments and further developments are revealed by the dependent claims.

According to the invention, in the case of the discharge apparatus described in the introduction, the delivery unit is arranged in the interior of the container in such a way that plant protection product located in the container can be delivered out of the container through the discharge orifice of the container by means of the delivery unit. Furthermore, according to the invention, the drive unit is arranged outside the interior of the container. It drives the delivery unit.

According to the invention, the delivery unit of the pump is therefore integrated in the container. It is therefore only used in connection with the plant protection product located in the container. Contamination of the plant protection product upon discharge by means of the delivery unit of the pump can thereby be prevented, since the delivery unit cannot be used in connection with other plant protection product containers.

According to one embodiment of the discharge apparatus according to the invention, the drive unit is fastened releasably to the container. This has the effect that the drive unit arranged outside the container can be released from the container in order to be used in connection with other plant protection product containers which also have a delivery unit in the interior of the container. As a result, it is possible to lower the distribution costs for a discharge system with the discharge apparatus according to the invention.

According to one embodiment of the discharge apparatus according to the invention, the drive unit generates a mechanical motion which is transmitted by a drive-through mechanism through the container wall mechanically to the delivery unit. The drive unit comprises, for example, a motor, which generates a rotary motion which is transmitted via a shaft to the delivery unit. The shaft in this case passes through the drive-through mechanism in the container wall and thereby connects the drive unit to the delivery unit. A sealed orifice is provided for the shaft, in particular, in the container wall. The rotational speed of the motor can in particular be set, controlled and/or regulated. In this way, the pump can be adapted to various plant protection products located in the interior of the container.

According to another embodiment, the drive unit drives the delivery unit hydraulically.

According to a further development of the discharge apparatus according to the invention, the latter has an electronic tag, which stores data relating to the plant protection product located in the container. In this case, it is preferable for the drive unit to have an electronic receiver, by means of which data stored by the electronic tag can be received. The drive unit can in this case be set, controlled or regulated depending on the data received by the receiver.

The electronic tag may be, for example, a radio tag or a transponder. By way of example, the tag comprises what is known as an RFID (Radio Frequency Identification) chip. In this case, the electronic receiver comprises a reader, which can receive and further process the data transmitted by radio. Alternatively, other wireless transmission standards can also be used, in particular those which make near-field communication possible.

An output device may be connected to the discharge orifice of the container. Said output device may for example be a spray gun via which the plant protection product may be sprayed out. The output device comprises an inlet orifice and an output orifice. A suitable nozzle may for example be provided at the output orifice.

The present invention further relates to the use of the above-described discharge apparatus for discharging a plant protection product located in the interior of the container. The discharge apparatus according to the invention is suitable in particular for discharging liquid plant protection products. The discharge apparatus according to the invention may for example be used in conjunction with liquid plant protection products formulated as EC, EW, SC, ME, SE or OD. These types of formulation are familiar to a person skilled in the art, and described for example in H. Mollet, A. Grubenmann “Formulation Technology”, WILEY-VCH, Weinheim 2001, pp. 389-397 and literature cited therein.

An EC is understood by a person skilled in the art to be a liquid plant protection product formulation in which the plant protection active ingredient(s) are present as a homogeneous solution in an organic solvent or solvent mixture immiscible with water, the solution producing an emulsion when diluted with water.

An EW is understood by a person skilled in the art to be a liquid plant protection product formulation in which the plant protection active ingredient(s) are present in the form of an oil-in-water emulsion, at least one of the plant protection active ingredients being present in the oil droplets.

An SC is understood by a person skilled in the art to be a liquid plant protection product formulation in which the plant protection active ingredient(s) are present in the form of solid, finely divided particles, which are suspended in an aqueous coherent phase. These formulations are also known as suspension concentrates.

An ME is understood by a person skilled in the art to be a liquid plant protection product formulation in which the plant protection active ingredient(s) are present in the form of a microemulsion, typically at least one of the plant protection active ingredients typically being dissolved in the organic phase.

An OD is understood by a person skilled in the art to be a liquid plant protection product formulation in which the plant protection active ingredient(s) are present in the form of solid, finely divided particles, which are suspended in a non-aqueous coherent phase. These formulations are also known as oil dispersion concentrates.

An SE is understood by a person skilled in the art to be a liquid plant protection product formulation in which the plant protection active ingredient(s) are present in the form of solid, finely divided particles, which are suspended in a non-aqueous liquid phase, which is in turn emulsified in an aqueous phase. These formulations are also known as suspo-emulsion concentrates.

In addition to one or more preferably organic plant protection active ingredients and at least one aqueous or non-aqueous diluent, the above-stated formulations generally comprise at least one surface-active substance, which is frequently selected from among anionic and non-ionic emulsifiers and from among anionic and non-ionic polymeric dispersion auxiliaries and which serves to form stable suspensions or emulsions when the formulation is diluted with water and, in the case of multiphasic liquid formulations such as EW, SC, ME, OD or SE, serves to stabilize the phases. The formulations optionally comprise “adjuvants”, which improve the efficacy of the plant protection product(s). Furthermore, the formulations generally comprise one or more additives, such as additives for modifying rheological properties, anti-freeze agents, colorants, and biocides in the quantities conventional for the respective formulation type.

The invention will now be explained with the aid of an exemplary embodiment and with reference to the figures.

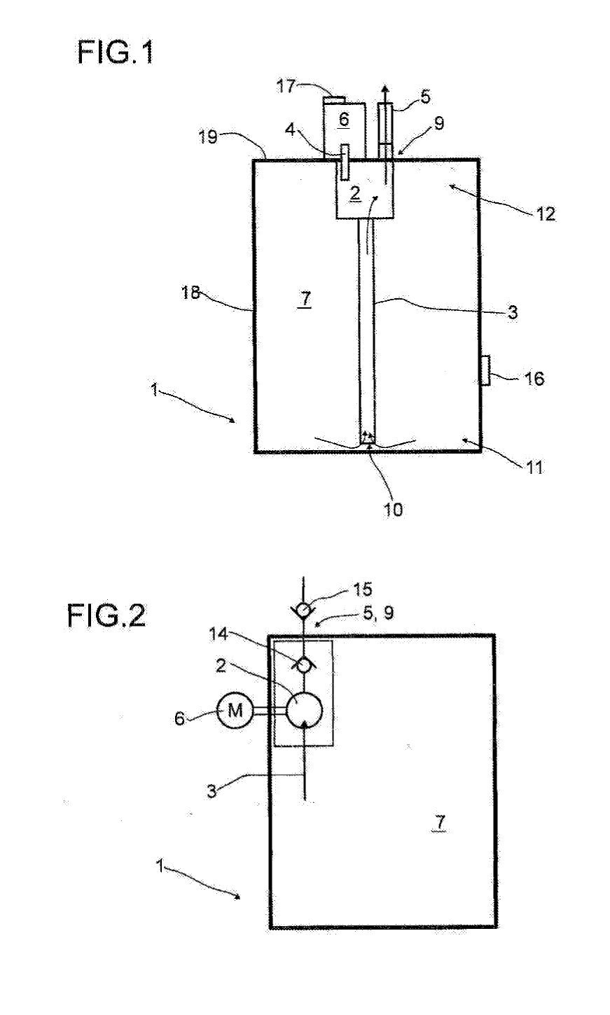

FIG. 1 shows a diagrammatic sectional representation of an exemplary embodiment of the discharge apparatus according to the invention,

FIG. 2 shows a circuit diagram of an exemplary embodiment of the discharge apparatus according to the invention including the output device.

The discharge apparatus comprises a container 1 which comprises an interior 7, a base 8, side walls 18 and an upper wall 19. The upper wall 19 comprises a discharge orifice 9. The plant protection product is accommodated in the interior 7 of the container 1.

A suction tube 3 is located within the discharge apparatus. The suction tube 3 comprises an orifice 10 which is arranged in the lower region 11 adjacent to the base 8 of the container 1. The orifice 10 is located as close as possible to the base 8. It is, however, located at such a distance from the base 8 that the liquid plant protection product may enter the suction tube 3 unimpeded via the orifice 10. The distance of the orifice 10 from the base 8 may for example depend on the viscosity of the plant protection product which is to be accommodated by the container 1.

The suction tube 3 extends from the orifice 10 in the vicinity of the base 8 of the container 1 to a delivery unit 2 of a pump of the discharge apparatus. The delivery unit is arranged in the interior 7 of the discharge apparatus. The plant protection product located in the interior 7 of the container 1 is aspirated by means of the delivery unit 2 at the orifice 10 of the suction tube 3 and delivered to the top through the delivery unit 2. In the upper region 12 of the container 1, a connector 5 passes from the delivery unit 2 through the discharge orifice 9 at the upper wall 19 of the container 1. The plant protection product located in the interior 7 of the container 1 is delivered out of the container 1 via this connector 5. By way of example, a hose, a line or a downstream output device, such as for example a spray gun, can be connected to the connector 5.

The pump of the discharge apparatus further comprises a drive unit 6. This is not, however, accommodated in the interior 7 of the container 1. Instead, it is fastened releasably to the outside of the container 1. For coupling the drive unit 6 to the delivery unit 2, a drive-through mechanism 4 is provided in the upper wall 19 of the container 1. By way of example, the upper wall 19 may comprise a further sealed orifice, through which a shaft passes. The shaft is coupled firstly to the delivery unit 2 and secondly to the drive unit 6. If the drive unit 6 is released from the discharge apparatus, in order to use it for example in connection with another discharge apparatus, the engagement of the shaft with the drive unit 6 is released.

The drive unit 6 comprises a motor, the rotary motion of which is transmitted via the shaft to the delivery unit 2. The motor is connected to a controller which sets, controls or regulates the rotational speed of the motor.

According to a special exemplary embodiment of the discharge apparatus, an electronic tag 16, such as for example an RFID chip, is fastened to the container 1 of the discharge apparatus according to the invention. Data relating to the plant protection product located in the interior 7 of the container 1 are stored on the RFID chip. The drive unit 6 further comprises an electronic receiver 17 which corresponds to the RFID chip and can read the data stored on the RFID chip. The receiver 17 transmits the data received from the RFID chip 16 to the controller of the drive unit 6. The controller then controls the motor of the drive unit depending on the received data. By way of example, the rotational speed of the motor can be controlled depending on the viscosity of the plant protection product located in the interior 7 of the container 1 or depending on the active ingredient or the active ingredient concentration of the plant protection product.

Once all of the plant protection product has been discharged from the interior 7 of the container 1, the drive unit 6 can thus be removed, the container 1 can be disposed of or processed for reuse and the drive unit 6 can be coupled to another container 1 for discharging the plant protection product located therein.

FIG. 2 shows the structure of the exemplary embodiment of the discharge apparatus on the basis of circuit symbols. The plant protection product located in the interior 7 is delivered via the suction tube 3 to the delivery unit 2 of the pump. The delivery unit 2 is driven by the motor of the drive unit 6. A non-return valve 14 is arranged downstream of the delivery unit 2 and, during uncoupling of the container 1, ensures that no plant protection product runs out or drips.

Downstream of the non-return valve 14, the plant protection product is delivered out of the container 1 through the discharge orifice 9 and the connector 5. A downstream output device may be connected to the connector 5. This may comprise a further non-return valve 15, which prevents the discharged plant protection product from being able to pass back into the interior 7 of the container 1.

The above-described discharge apparatus is used according to exemplary embodiments of the invention for the plant protection products mentioned in the introduction. For this use, these plant protection products are filled into the interior 7 of the container 1. They are then sprayed in a desired manner, for example by means of an output device.

### List of Reference Numerals

1 Container
2 Pump
3 Suction tube
4 Drive-through mechanism
5 Connector
6 Motor
7 Interior of the container 1
8 Base of the container 1
9 Discharge orifice of the container 1
10 First orifice of the suction tube 3
11 Lower region of the container 1
12 Upper region of the container 1
14 Non-return valve
15 Non-return valve
16 Electronic tag
17 Electronic receiver
18 Side wall of the container 1
19 Upper wall of the container 1

1-8. (canceled)

9. A discharge apparatus for a plant protection product with
a container (1), which has a container wall (8, 18, 19) and a discharge orifice (9), the container wall (8, 18, 19) enclosing an interior (7) for accommodating the plant protection product, and
a pump (2, 6), which comprises a delivery unit (2) and a drive unit (6), wherein
the delivery unit (2) is arranged in the interior (7) of the container (1) in such a way that plant protection product located in the container (1) can be delivered out of the container (1) through the discharge orifice (9) of the container (1) by means of the delivery unit (2), and
the drive unit (6) is arranged outside the interior (7) of the container (1) and drives the delivery unit (2).

10. The discharge apparatus according to claim 9, wherein the drive unit (6) is coupled releasably to the container.

11. The discharge apparatus according to claim 9, wherein the drive unit (6) generates a mechanical motion which is transmitted by a drive-through mechanism (4) through the container wall (19) mechanically to the delivery unit (2).

12. The discharge apparatus according to claim 11, wherein the drive unit (6) comprises a motor, which generates a rotary motion which is transmitted via a shaft to the delivery unit (2).

13. The discharge apparatus according to claim 12, wherein the rotational speed of the motor can be set, controlled or regulated.

14. The discharge apparatus according to any one of the preceding claims, wherein the discharge apparatus has an electronic tag (16), which stores data relating to the plant protection product located in the container (1).

15. The discharge apparatus according to claim 14, wherein the drive unit (6) comprises an electronic receiver (17), by means of which data stored by the electronic tag (16) can be received, and wherein the drive unit (6) can be set, controlled or regulated depending on the data received by the receiver (17).
